(19) United States
(12) Patent Application Publication
(10) Pub. No.: US 2014/0224179 A1
(43) Pub. Date: Aug. 14, 2014

(54) AC POWERED ALL WEATHER AUTOMATIC GRANULAR FEEDER

(71) Applicant: Mark Francis Mignone, Holbrook, NY (US)

(72) Inventor: Mark Francis Mignone, Holbrook, NY (US)

(21) Appl. No.: 13/763,495

(22) Filed: Feb. 8, 2013

(51) Int. Cl. A01K 61/02

(52) U.S. Cl. CPC A01K 61/02
USPC 119/51.04; 119/57.92

(57) ABSTRACT

An automatic, all-weather, AC-powered feeder can be used to supply feed to a fish pond, for example. The feeder does not clog and can be set to dispense an exact amount of food periodically. The feeder includes a hopper for holding food, such as a granular fish food. A power feed auger can be powered by an electric motor to carry food from the auger, down a main pipe, to a dispensing hole. Therefore, the hopper is not required to be positioned over the pond, but, instead, only the main pipe is disposed over the pond to release food from the dispensing hole.

### BACKGROUND OF THE INVENTION

The present invention relates to feeders and, more particularly, to an all-weather, alternating current (AC) powered automatic granular feeder that is particularly suited for distribution of fish food for outdoor fish ponds, such as decorative koi ponds, for example.

Fish ponds have been increasing in popularity. Many homeowners and businesses install these ponds, which can vary in size from a few hundred gallons to thousands of gallons. While an attractive addition, especially when eye-catching and expensive koi fish are placed in the pond, there is a need to feed the fish, often daily when the fish are active.

Fish feeding can be problematic. Where multiple people may be responsible for the pond, the fish can be fed too much or too little food. Even when only one person is responsible for feeding, they may be on vacation, forget, or double feed when then can't recall whether a certain day's feeding has occurred.

Home-based ponds can become an issue when the members of the household go away for a vacation. Often, they have to rely on others to feed the fish, which can be unreliable. There are limited options for automatically supplying food to a pond.

Some feeders include a small hopper and a rotating shaft with a plurality of flaps attached thereto. The shaft is disposed at a lower opening of the hopper and the flaps seal this opening when not turning. In theory, a battery-powered motor would turn the shaft, turn the flaps, and permit an amount of food to be released from the hopper. These feeders, however, often jam, as the battery-powered motor is not strong enough to turn the shaft and flaps when the hopper is filled. Moreover, once jammed, the shaft can become disengaged from the flaps, thereby allowing the shaft to turn without turning the flaps and not releasing food as desired.

Other battery powered feeders can use vibrations to release food from a hopper. While these feeders do not suffer from issues with turning shafts, these feeders can release an unpredictable amount of food into the pond—from no food when the hopper gets jammed, to a full “dose” of food when the food is free-flowing, and any amount in between.

Many of the conventional automatic feeders simply drop food from their hopper. Therefore these feeders need to be disposed over the pond itself, decreasing the natural beauty of the pond and often requiring a separate support structure.

As can be seen, there is a need for an improved automatic feeder that can distribute a consistent amount of food into a pond while being weather proof and powered by reliable AC power.

### SUMMARY OF THE INVENTION

In one aspect of the present invention, an automatic feeding device comprises a hopper assembly operable to hold food; a hopper bottom adapter having a food supply hole for release of food from the hopper assembly; a power feed auger receiving food released from the hopper assembly; a motor driving the power feed auger; a main pipe containing the power feed auger; and a food dispensing hole disposed at a distal end of the main pipe, wherein the power feed auger turns to move the food down the main pipe and out of the food dispensing hole during operation of the automatic feeding device.

In another aspect of the present invention, an automatic feeding device comprises a hopper assembly operable to hold food; a hopper bottom adapter having a food supply hole for release of food from the hopper assembly; a first tee, wherein an orthogonal connection point of the first tee receives food from the food supply hole of the hopper bottom adapter; a power feed auger receiving food released from the hopper assembly; a motor driving the power feed auger; a main hub connected to a first end of the first tee; a motor adapter connected to the main hub, the motor adapter supporting the motor; a motor cover pipe disposed from the motor adapter, covering the motor; a motor cover pipe cap disposed on an end of the motor cover pipe; a main pipe containing the power feed auger, the main pipe connected to a second end of the first tee; and a food dispensing hole disposed at a distal end of the main pipe, wherein the power feed auger turns to move the food down the main pipe and out of the food dispensing hole during operation of the automatic feeding device.

These and other features, aspects and advantages of the present invention will become better understood with reference to the following drawings, description and claims.

### BRIEF DESCRIPTION OF THE DRAWINGS

FIG. 1 is a perspective view of an automatic feeder according to an exemplary embodiment of the present invention;

FIG. 2 is a cross sectional view taken along line 2-2 of FIG. 1;

FIG. 3 is an exploded perspective view of the automatic feeder of FIG. 1 with all fasteners and food pellets removed for clarity;

FIG. 4 is an exploded perspective view of a motor/drive assembly of the automatic feeder of FIG. 1; and

FIG. 5 is an exploded perspective view of a food hopper assembly of the automatic feeder of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an automatic, all-weather, AC-powered feeder that can be used to supply feed to a fish pond, for example. The feeder does not clog and can be set to dispense an exact amount of food periodically. The feeder includes a hopper for holding food, such as a granular fish food. A power feed auger can be powered by an electric motor to carry food from the auger, down a main pipe, to a dispensing hole. Therefore, the hopper is not required to be positioned over the pond, but, instead, only the main pipe is disposed over the pond to release food from the dispensing hole.

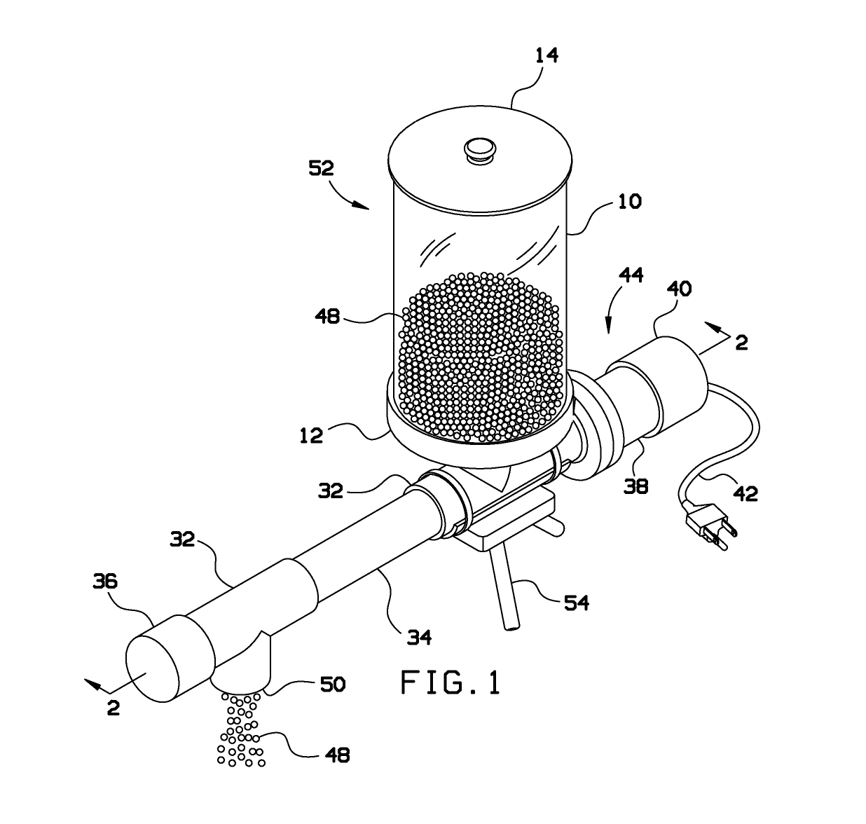

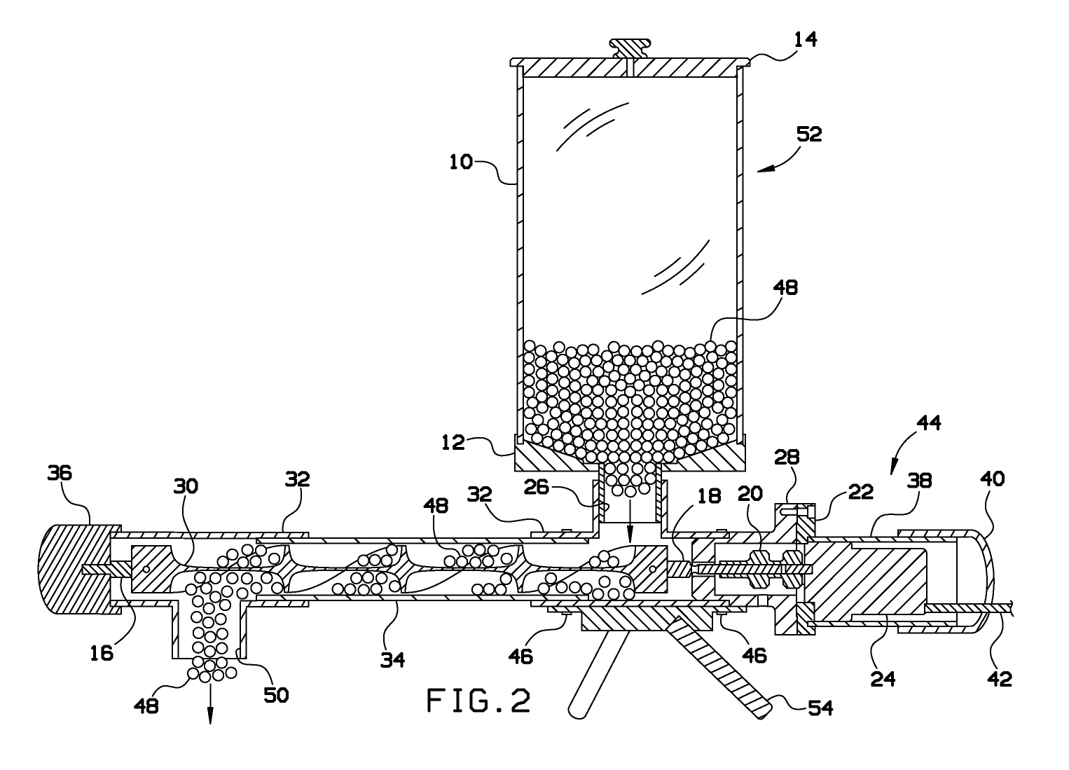

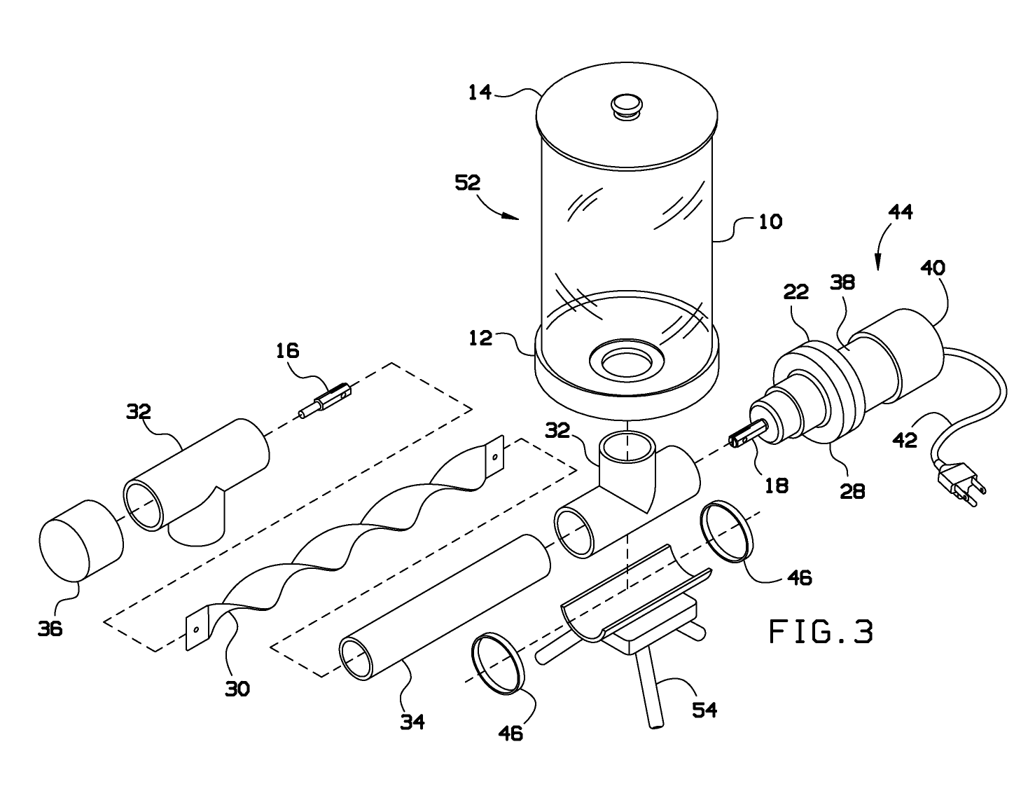

Referring now to FIGS. 1 through 5, an automatic feeder can include a hopper assembly 52 for containing food 48. The hopper assembly 52 typically includes a transparent, cylindrical member 10, a hopper bottom adapter 12 and a hopper top cover 14. The hopper top cover 14 can provide a weather proof cap for the cylindrical member 10. The hopper bottom adapter 12 can provide a sloped bottom surface (see FIG. 2) that slopes a food pellet supply hole 26 formed in the hopper bottom adapter 12. The food pellet supply hole 26 can fit into or be formed integrally with a tee 32, connecting with the orthogonal connection point of the tee 32.

A main hub 28 can attach to a first end of the tee 32. A motor/drive assembly 44 can include a motor adapter 22 that can mount to the main hub 28. The motor adapter 22 can support a motor 24. Typically, the motor 24 is a direct current (DC)-powered motor. The motor 24 can be housed in a motor cover pipe 38 running from the motor adapter 22 and terminating with a motor pipe cap 40. A power cord 42 for the motor 24 can extend out of the motor pipe cap 40. In some embodiments, an AC to DC transformer can be disposed at the plug end of the cord and the power cord 42 can carry low voltage (such as 12-volt or 24-volt, for example) direct current to the motor 24. In other embodiments, an AC to DC transformer can be disposed in the device itself and the power cord 42 can carry AC power to the device. In this configuration, should a replacement motor be needed, the user can simply disconnect the motor adapter 22 from the main hub 28 to remove the motor for replacement.

A main pipe 34 can attached to a second, opposite end of the tee 32. The main pipe 34 can be from about 12 to about 48 inches long, for example, and can include a second tee 32 disposed therein. The orthogonal connection point of the second tee 32 is typically 180 degrees from the orthogonal connection point of the tee 32 where the hopper bottom adapter 12 connects. A main pipe cap 36 can be disposed on the end of the second tee 32 (or on a short pipe that connects the second tee 32 with the main pipe cap 36).

The feeder can include a feeder stand 54. The feeder stand 54 can take various configurations, provided that it can support the feeder. For example, the feeder stand 54 can include a plurality of stand straps 46 for securing the feeder thereto. The stand 54 can be free-standing, or could be mounted on a deck, in the ground, into concrete, or the like, to provide a stable support structure.

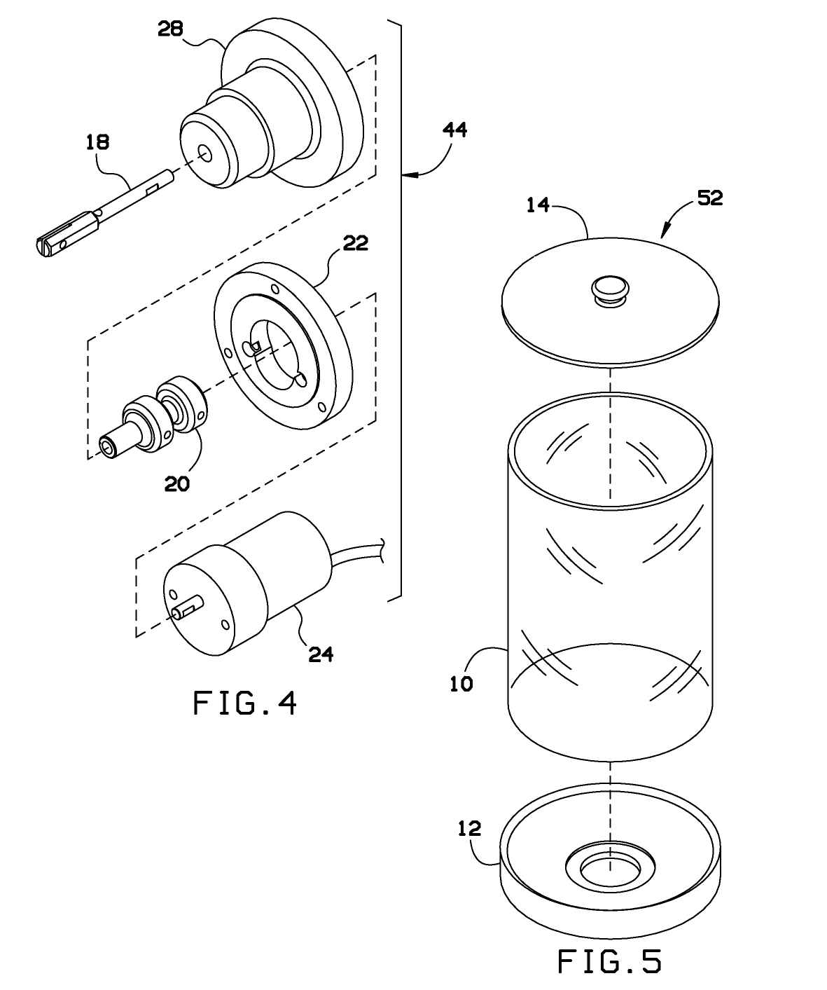

The motor 24 can be mechanically connected to a power feed auger 30. In some embodiments, as shown in FIGS. 2 and 4, a coupling 20 can be mounted in the motor adapter 22 and a drive shaft 18 can pass through the coupling 20 to connect with the motor 24 on one end of the drive shaft 18 and connect to the power feed auger 30 on the other end of the drive shaft 18.

The power feed auger 30 can pass under the food pellet supply hole 26, receiving food 48 from the hopper assembly 52. As the motor 24 turns, the power feed auger 30 turns and drives the food 48 down the main pipe 34, to the second tee 32 and out a food pellet dispensing hole 50 (which can be simply the orthogonal connection point of the second tee 32, or could be a pipe (not shown) connected to the second tee 32. The distal end of the power feed auger 30 can be supported by the main pipe cap 36 with an end shaft 16.

In some embodiments, the motor 24 can be designed to slowly turn at a predetermined (or adjustable) speed, thereby continuously delivering a given quantity of food out of the food pellet dispensing hole 50. In other embodiments, the motor 24 can be programmed to operate for a set amount of time, turn off for a set off-time, and repeat. This operation can mimic a user's manual feeding, for example, on a twice a day cycle. Appropriate programming hardware and/or software can be provided, as may be known in the art, to cycle the motor 24 appropriately.

While the Figures show an exemplary embodiment of the present invention, certain sizes and shapes can be re-configured within the scope of the present invention. For example, while the drawings show a cylindrical hopper assembly 52, the hopper assembly could be made in various geometric or non-geometric shapes, such as square, triangular, rectangular, pyramidal, or the like. While the Figures show relative length of the main pipe 34, and relative dimensions of the main pipe 34 and hopper 10, for example, these relative sizes can vary. Typically, the main pipe 34 can be from about ¾ to about 2 inches in diameter, while the hopper can be from about 4 inches to about 12 inches in diameter and from about 6 inches to about 24 inches, or more, high. Of course, the sizes and shapes can be altered depending on application and user preference and such changes are contemplated within the scope of the present invention

It should be understood, of course, that the foregoing relates to exemplary embodiments of the invention and that modifications may be made without departing from the spirit and scope of the invention as set forth in the following claims.

What is claimed is:

1. An automatic feeding device comprising:
a hopper assembly operable to hold food;
a hopper bottom adapter having a food supply hole for release of food from the hopper assembly;
a power feed auger receiving food released from the hopper assembly;
a motor driving the power feed auger;
a main pipe containing the power feed auger; and
a food dispensing hole disposed at a distal end of the main pipe, wherein
the power feed auger turns to move the food down the main pipe and out of the food dispensing hole during operation of the automatic feeding device.

2. The automatic feeding device of claim 1, wherein the hopper assembly includes a hopper top cover providing a weather-proof cover for a hopper body.

3. The automatic feeding device of claim 1, further comprising a first tee, wherein an orthogonal connection point of the first tee receives food from the food supply hole of the hopper bottom adapter.

4. The automatic feeding device of claim 3, further comprising:
a main hub connected to a first end of the first tee;
a motor adapter connected to the main hub, the motor adapter supporting the motor;
a motor cover pipe disposed from the motor adapter, covering the motor; and
a motor cover pipe cap disposed on an end of the motor cover pipe.

5. The automatic feeding device of claim 4, wherein the main pipe is connected to a second end of the first tee.

6. The automatic feeding device of claim 4, further comprising a drive shaft extend through the main hub and the motor adapter to mechanically connect the motor with the power feed auger.

7. The automatic feeding device of claim 1, further comprising:
a main pipe cap disposed on a distal end of the main pipe; and
an end shaft connecting the main pipe cap with the power feed auger.

8. The automatic feeding device of claim 1, further comprising a second tee disposed at a distal end of the pipe, wherein the orthogonal connection point of the second tee provides a food pellet dispensing hole, releasing food out of the automatic feeding device during operation thereof.

9. The automatic feeding device of claim 4, further comprising a power cord passing through the motor cover pipe cap, the power cord operable for connect to an alternating current power supply.

10. The automatic feeding device of claim 1, further comprising a stand for support the automatic feeding device.

11. An automatic feeding device comprising:
a hopper assembly operable to hold food;
a hopper bottom adapter having a food supply hole for release of food from the hopper assembly;
a first tee, wherein an orthogonal connection point of the first tee receives food from the food supply hole of the hopper bottom adapter;
a power feed auger receiving food released from the hopper assembly;
a motor driving the power feed auger;
a main hub connected to a first end of the first tee;
a motor adapter connected to the main hub, the motor adapter supporting the motor;
a motor cover pipe disposed from the motor adapter, covering the motor;
a motor cover pipe cap disposed on an end of the motor cover pipe;
a main pipe containing the power feed auger, the main pipe connected to a second end of the first tee; and
a food dispensing hole disposed at a distal end of the main pipe, wherein
the power feed auger turns to move the food down the main pipe and out of the food dispensing hole during operation of the automatic feeding device.

12. The automatic feeding device of claim 11, further comprising a drive shaft extend through the main hub and the motor adapter to mechanically connect the motor with the power feed auger.

13. The automatic feeding device of claim 11, further comprising:
a main pipe cap disposed on a distal end of the main pipe; and
an end shaft connecting the main pipe cap with the power feed auger.

14. The automatic feeding device of claim 11, further comprising a second tee disposed at a distal end of the pipe, wherein the orthogonal connection point of the second tee provides a food pellet dispensing hole, releasing food out of the automatic feeding device during operation thereof.
